(19) United States
(12) Patent Application Publication
(10) Pub. No.: US 2026/0267855 A1
(43) Pub. Date: Sep. 10, 2026

(54) OPTIMIZING CONTENT VISIBILITY AND SENTIMENT IN AI-DRIVEN CONVERSATIONAL PLATFORMS

(71) Applicant: Ecomtent Inc., Toronto (CA)

(72) Inventors: Timur Luguev, Toronto (CA); Max Sinclair, London (GB); Erkan Ege Senli, Toronto (CA); Cassandra Wong, North York (CA); Kamal Shakhdullaev, Toronto (CA); Gloria Lim, Mississauga (CA)

(21) Appl. No.: 19/073,444

(22) Filed: Mar. 7, 2025

(51) Int. Cl. G06F 16/2453; G06F 16/2457

(52) U.S. Cl. CPC G06F 16/24542; G06F 16/24578

(57) ABSTRACT

A system and method for optimizing content visibility and sentiment in AI-driven conversational platforms is disclosed, performed on a server. The method involves collecting and aggregating AI-generated responses related to a target content, computing baseline visibility and sentiment metrics. A digital twin model or simulation of an AI model is instantiated to replicate AI response behaviour in a controlled environment. The method analyzes test responses by comparing them to external content corpora to identify authoritative sources that influence AI-generated outputs. Using a feedback loop, the system generates modified content versions, refining coverage, phrasing alignment, and sentiment based on authority analysis and predefined optimization rules. The modified content is tested in the digital twin, evaluated for improvements, and iterated until predefined optimization criteria are met. The optimized content configuration is deployed to live AI platforms or content repositories for enhanced representation in AI-generated responses and content accuracy.

### FIELD OF THE INVENTION

The field of the invention is artificial intelligence (AI), natural language processing, and digital marketing and, in particular, methods and systems for analyzing and optimizing content visibility and sentiment within AI-driven conversational platforms.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

As AI-driven conversational platforms (e.g., ChatGPT™, Grok™, Perplexity™ Google Gemini™) increasingly supplement or replace traditional search engine results pages, brands and other content providers face significant challenges in maintaining and improving their visibility and sentiment within AI-generated content.

Unlike classical search where a brand or content provider can optimize a webpage to rank higher, AI chatbots generate answers by synthesizing information from various sources, often without direct reference to source content. This opacity of large language models (LLMs)—operating as “black boxes”—makes it difficult to predict how brands and other references will be interpreted or generated. Moreover, AI chatbot providers typically do not disclose detailed usage metrics or ranking signals, hindering direct measurement of a brand's performance in these channels.

Existing approaches have attempted to apply legacy search engine optimization (SEO) or basic content creation strategies to this new medium. These approaches rely on techniques directed to traditional search engines like Google™ and Bing™, or simple keywords for chatbot prompts. These fragmented techniques treat AI-driven conversations as merely an extension of traditional SEO. For example, prior art exists for improving web search rankings using AI (e.g., US2022414167A1), and for ranking brands based on sentiment derived from web content (e.g., US2012254149A1). While such references use natural language processing (NLP) and sentiment analysis to influence search results, they are focused on conventional search engines or e-commerce SEO and do not address the unique context of AI chatbot-generated content. Other disclosures relate to NLP-based summarization and sentiment analysis (e.g., US2023164098A1) but are directed towards IT or general applications rather than content management in AI platforms. Likewise, existing chatbot technologies emphasize conversation quality or intent recognition (e.g., KR102653266B1) without addressing brand-specific visibility or sentiment control.

Prior solutions do not provide an integrated approach to analyzing and optimizing content visibility, sentiment, and ranking within AI-generated search results and chatbot responses. Aspects such as sentiment analysis, NLP-based search ranking, or AI-driven content optimization have been explored, but these do not combine to address how AI chatbots select and present brand content in practice.

Thus, there is a need for a system that can track and evaluate a content provider's representation in AI-driven conversational outputs, discover the underlying information sources and factors influencing that representation, and implement techniques to enhance the visibility of content and sentiment in such AI-generated content. There is a need for methods and systems for enhancing content visibility and sentiment in LLM-based conversational platforms, addressing the limitations of existing approaches. There is also a need to provide alternatives to existing systems and methods.

### BRIEF DESCRIPTION OF DRAWINGS

Various objects, features, aspects, and advantages of the inventive subject matter will become more apparent from the following detailed description of preferred embodiments, along with the accompanying drawing figures in which like numerals represent like components.

FIG. 1 is a block diagram of an exemplary system architecture for an AI-driven content optimization system, in accordance with an example of the present specification.

FIG. 2 is a flowchart illustrating the operational workflow of the system of FIG. 1.

FIG. 3 is a screenshot of an exemplary topic submission and initial analysis interface within the system of FIG. 1.

FIG. 4 is a screenshot of an exemplary automated data collection interface for querying AI conversational platforms within the system of FIG. 1.

FIG. 5 is a screenshot of an exemplary data analysis and visualization dashboard displaying sentiment analysis and competitive benchmarking within the system of FIG. 1.

FIG. 6 is a screenshot of an exemplary citation aggregation and authority analysis interface within the system of FIG. 1.

FIG. 7 is a screenshot of an exemplary recommendations dashboard providing actionable insights for content optimization within the system of FIG. 1.

### DETAILED DESCRIPTION OF THE INVENTION

This detailed description provides an explanation of the embodiments of the present specification. The present specification encompasses a variety of systems, methods, and non-transitory computer-readable media.

The present specification is directed to methods and systems for optimizing content visibility and sentiment in AI-driven conversational platforms. As described herein, the method is performed on a server equipped with a processor, memory, data storage, and a network interface device. The method includes collecting and aggregating data from one or more AI-driven conversational platforms, including retrieving user queries and corresponding AI-generated responses related to a target content and computing baseline metrics of content visibility and sentiment. The method further includes instantiating a digital twin model or simulation of an AI conversational model, wherein the digital twin is configured with the target content and simulates the behaviour of a live conversational platform, enabling controlled testing of AI-generated responses. The method includes identifying authoritative sources by analyzing external content corpora to determine which external content pieces or data sources influence the responses for topics related to the target content. The method further includes iteratively optimizing the target content via a feedback loop, wherein modified versions of the target content are generated based on insights from the authority profile and predefined optimization rules to improve at least one of content coverage of missing information, alignment with authoritative phrasing or tone, and sentiment conveyed. The modified content is input into the digital twin model and re-run against a plurality of test queries to obtain simulated responses. The method includes evaluating the simulated responses by an automated analysis to measure updated content visibility and sentiment metrics, iteratively refining content modifications until predefined improvement criteria are met. The optimized content configuration is deployed to the live AI conversational platform or an associated content repository, ensuring that subsequent AI-generated responses incorporate the optimizations. This detailed description and the accompanying drawings provide sufficient information to enable one of ordinary skill in the art to practice the claimed invention, and the described embodiments illustrate the application of the principles of the claimed methods and systems.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of features used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

One embodiment of the disclosed methods and systems relates to automated content optimization in AI-driven conversational platforms, using artificial intelligence algorithms to enhance content visibility and sentiment in AI-generated responses. Executed on a server equipped with a processor, memory, data storage, and network connectivity, this method improves the representation and prominence of target content, such as brand information, within conversational AI outputs. According to this embodiment, the process begins by collecting and aggregating data from one or more AI-driven conversational platforms, including retrieving user queries and corresponding AI-generated responses related to the target content. The system analyzes this data to compute baseline content visibility and sentiment metrics, forming the basis for subsequent optimization steps.

According to this embodiment, a digital twin simulation or model of an AI conversational model is instantiated, configured with the target content, and used to simulate AI-generated responses in a controlled environment. The system identifies authoritative sources by comparing AI-generated responses with external content corpora to determine which external content pieces or data sources influence the AI's output. The system generates an authority profile based on these findings, identifying content gaps, tone mismatches, and opportunities for optimization.

According to examples of the present specification, content optimization refers to the creation of modified versions of the target content or associated metadata, incorporating predefined optimization rules to improve at least one of content coverage of missing information, alignment with authoritative phrasing or tone, and sentiment conveyed. An optimization engine or module iteratively refines the target content by inputting the modified content into the digital twin model, re-running test queries, and evaluating simulated AI responses to measure updated visibility and sentiment metrics.

In accordance with examples of the present specification, a loss-guidance framework is applied to minimize deviations between AI-generated responses and the target content's intended visibility and sentiment. The system dynamically updates authority scoring models based on AI responses, ensuring that refinements align with high-impact authoritative sources. The optimization process incorporates A/B testing across multiple content variations, evaluating which modifications yield superior AI response behaviour. The final optimized content version is deployed to the live AI conversational platform or an associated content repository, ensuring that subsequent AI-generated responses incorporate the optimizations. The system presents actionable recommendations for further content refinement, based on an analysis of visibility trends, sentiment shifts, and changes in authoritative source rankings. The system also enables continuous monitoring of AI-generated responses, detecting content drift due to AI model updates and triggering re-optimization cycles as needed, ensuring content relevance and positive sentiment representation in AI-driven conversations.

The system architecture supports these functionalities, with a processor executing instructions stored in memory to perform the method. A non-transitory computer-readable storage medium contains instructions for executing the content optimization process across multiple AI-driven conversational platforms and environments. A computer system may include one or more processors, memory, and storage devices, configured with software and/or firmware to implement the specified functionalities, including data collection, AI response aggregation, digital twin simulation, authority analysis, content modification, and iterative feedback-driven optimization. The system is designed to adapt to evolving AI models, enabling real-time monitoring of content visibility and sentiment, for continuous performance improvements and alignment with authoritative sources.

According to examples of the present specification, large language models (LLMs) serve as the foundation for AI-generated responses, utilizing transformer-based architectures to process and generate human-like text. These models are trained on vast corpora and employ retrieval-augmented generation (RAG) techniques to reference external data sources dynamically.

The term “digital twin” refers to a surrogate model designed to replicate or simulate the behaviour of a target AI-driven conversational platform. A digital twin may be a fine-tuned version of a pre-existing LLM or a purpose-built transformer-based architecture, optimized to mirror the response generation patterns of the live AI system. Fine-tuning refers to a machine learning process in which a pre-trained neural network is further trained on a specialized dataset to adjust its weights and parameters for improved performance on a specific task. In the context of the present specification, fine-tuning involves training an LLM-based digital twin on a corpus of AI-generated responses, user queries, and authoritative content to approximate how a live conversational AI system processes and responds to information. Fine-tuning may use supervised learning, where response-label pairs are provided, or unsupervised learning, where the model adjusts based on inferred patterns within the collected data. These models may employ RAG, embedding-based similarity retrieval, or context-aware response conditioning to align their outputs with the AI's expected responses. The digital twin may incorporate knowledge distillation, a process in which a smaller, more efficient model learns to replicate the behaviour of a larger, more complex AI system. This enables the digital twin to operate efficiently in a controlled simulation environment, where content modifications can be tested without affecting real-time AI interactions.

Brand information refers to any structured or unstructured data associated with an entity, organization, or product line that contributes to its identity, perception, and recognition in AI-driven conversational platforms. This information includes brand names, product descriptions, service offerings, company values, historical background, pricing models, customer testimonials, and marketing messages. Topics related to a brand may cover industry trends, consumer sentiment, competitive comparisons, and frequently asked questions, all of which influence how AI platforms reference and present the brand in responses. For instance, a consumer electronics company may have brand information comprising specifications of its latest smartphones, warranty policies, and sustainability initiatives, while a financial institution may have topics covering investment strategies, interest rates, and customer security measures. The techniques disclosed herein are general and extend beyond marketing and brand-specific contexts.

The system is not limited to brand optimization but applies broadly to the enhancement of any structured or unstructured content in AI-driven responses, for improved visibility, accuracy, and sentiment alignment across diverse application areas. The term “content” includes, but is not limited to, textual descriptions, factual data, metadata, user-generated content, research articles, corporate documentation, product specifications, regulatory information, and knowledge base entries. Content may originate from a variety of sources, such as official brand communications, third-party publications, industry reports, customer interactions, publicly available datasets, and and social media platforms, including X™, Facebook™, Reddit™, LinkedIn™, YouTube™ Instagram™, and TikTok™ as non-limiting examples. The techniques disclosed herein are applicable to content spanning multiple domains, including but not limited to marketing, education, healthcare, legal, financial, technical, and scientific applications.

Brand misinformation occurs when AI-driven conversational platforms generate responses that contain inaccurate, outdated, misleading, or biased information about a brand, its products, or its services. This can arise from hallucinated facts, reliance on low-authority sources, misinterpretation of data, or an overemphasis on negative user-generated content. For example, an AI assistant might incorrectly state that a pharmaceutical product is no longer approved when it is still legally available, misattribute a faulty recall to the wrong company, or provide outdated pricing information for a subscription service. Another instance could involve an AI-generated response unfairly emphasizing negative reviews while overlooking customer satisfaction metrics from more authoritative sources. Systems according to the disclosed examples aim to overcome misinformation by identifying authoritative sources, analyzing content gaps, and iteratively optimizing content to align with verified data. Through digital twin simulation, reinforcement learning-based refinement, and continuous AI response monitoring, the system ensures that brand-related content is accurately represented, contextually balanced, and continuously updated to reflect the most reliable and favorable portrayal within AI-generated responses.

An exemplary method begins with the collection and aggregation of data from multiple AI conversational platforms. User queries and corresponding AI-generated responses related to a target brand or topic are retrieved and analyzed to compute baseline content visibility and sentiment metrics. The system applies an automated topic submission and analysis process, where the customer supplies a list of topics pertinent to their brand or business. The system then queries multiple AI platforms, capturing variations in response representation. The AI Visibility Score (V) is computed as a quantitative metric reflecting the frequency and prominence of the target content over time, defined as:

$$V = \frac{1}{T} {\sum }_{t = 1}^{T} f ( B , t ) \qquad ( 1 )$$

where f(B, t) represents the degree of brand presence at time t, and T is the total observation period. The system generates graphs depicting V over time, enabling customers to evaluate how subsequent optimization efforts impact overall brand awareness.

To capture the probabilistic nature of AI-generated outputs, a transformer-based prediction model generates a diverse set of synthetic user queries. Each question is submitted multiple times across AI platforms, and responses are aggregated into a continuously updated dataset. The dataset serves as an indirect measure of public perception and sentiment, forming the basis for deep-learning-based sentiment analysis. A sentiment classification model assigns polarity scores to extracted brand mentions, producing structured performance indicators, including Reputation, Price, Quality, and Customer Service scores. These indicators are displayed in interactive dashboards, with comparative benchmarking metrics that assess the brand's positioning relative to competitors.

A well known limitation in AI conversational optimization is the lack of direct access to user search behaviour within these platforms. To address this, systems according to the present specification integrates predictive AI search volume estimation using web traffic data, leveraging raw web traffic logs from data provider partnerships. The system detects AI-related web crawlers (e.g., GPTBot™, GoogleBot™ PerplexityBot™ as non-limiting examples) by analyzing visit frequency, dwell time, and access patterns, allowing inference of which external sources AI platforms index for content ingestion. Features indicative of crawler behaviour, including periodic access from specific IP ranges and recurring user-agent strings, are extracted to form a feature vector C. A transformer-based deep learning model then maps C to an estimated AI search volume V_{predicted} where:

$${V}_{p redicted} = F ( C , θ ) \qquad ( 2 )$$

where θ represents the learned model parameters. The system incorporates time-series forecasting and adaptive learning, dynamically updating θ based on newly observed crawler patterns, ensuring continuous refinement of AI search volume predictions. The estimation process is represented as:

$${V}_{p redicted} ( t ) = F ( C ( t ) , θ ( t ) ) \qquad ( 3 )$$

where t is the time index, and C(t) is the feature vector at time t and θ(t) reflects the dynamically updated parameters. This predicted search volume informs subsequent stages of brand optimization by correlating crawler activity with user search intent, complementing the analytics that drive text optimization and content distribution strategies.

To refine and optimize marketing content for enhanced AI-driven visibility, the system develops a digital twin model, a surrogate deep-learning-based environment designed to replicate the behaviour of AI conversational platforms. According to one example, the digital twin model is constructed through three steps. First, the system collects a large set of input-output pairs by querying AI platforms with a diverse range of prompts. Second, using this dataset, a fine-tuned transformer model is trained to approximate the distribution of AI-generated responses, ensuring that it statistically aligns with real-world outputs. Third, the digital twin model is validated by comparing its predictions against actual responses from live AI platforms, confirming its ability to accurately mimic the behaviour of target AI systems.

Once validated, the digital twin enables structured content optimization by testing candidate content modifications in a controlled environment. The system applies reinforcement learning techniques to iteratively adjust content until the AI-generated responses consistently reflect improved visibility and sentiment alignment. Let S denote the marketing content to be optimized, and X represent structured brand data (e.g., product descriptions, pricing details, and quality metrics). The optimization objective is to minimize the cross-entropy loss between the AI-generated response O and an idealized target response T that maximizes brand prominence, formulated as:

$$L ( S ) = - log P ( T \vert S , X ) \qquad ( 4 )$$

The system employs an iterative gradient-based update rule:

$${S}^{( i + 1 )} = {S}^{i} - η \cdot {∇}_{S} L ( {S}^{( i )} ) \qquad ( 5 )$$

where S⁽ⁱ⁾ is the content at iteration i, η is the learning rate, and ∇_{S}L(S⁽ⁱ⁾) denotes the gradient of the loss function with respect to the content at iteration i. For discrete token spaces, a greedy substitution strategy replaces tokens with alternatives that yield the maximum reduction in loss. By applying this method iteratively, the system refines content until it optimally aligns with AI response generation dynamics.

Once optimized content has met predefined performance thresholds, the system deploys the final version to live AI platforms and associated content repositories. Deployment mechanisms include direct Application Programming Interface (API)-based content injection, structured metadata formatting for retrieval augmentation, and strategic content distribution across web-based channels to maximize AI model ingestion. The system further integrates automated monitoring, tracking real-time AI-generated responses to detect content drift, model updates, and evolving query trends. If a degradation in visibility or sentiment is detected, the system automatically re-initiates the optimization cycle, ensuring that brand representation remains consistently favorable.

To automate the end-to-end process, the system incorporates a multi-agent framework that governs content analysis, generation, and distribution. A content generation agent leverages reinforcement learning with human feedback (RLHF) to generate AI-optimized marketing content. A distribution agent determines the optimal publication schedule and content dissemination strategy, employing predictive analytics to identify peak engagement periods. The distribution process is modeled as a reinforcement learning optimization problem, where the system selects distribution actions (i.e., the decisions regarding publication timing and channel selection, denoted here as A) to maximize engagement-based rewards, given by:

$${max}_{θ} {E}_{A ∼ {π}_{θ}} [ R ] \qquad ( 6 )$$

where R represents real-time engagement metrics, and π_{θ} is the policy controlling content publication timing and channel selection. The policy gradient update rule is applied as:

$$θ ← θ + η \cdot R \cdot {∇}_{θ} log ( {π}_{θ} ( A \vert X ) ) \qquad ( 7 )$$

ensuring that content is dynamically adapted based on real-time audience interactions. A monitoring agent continuously tracks engagement data, sentiment evolution, and AI citation frequency, providing live feedback for adaptive content refinement.

At the highest level, an asynchronous orchestration layer ensures seamless coordination among agents, utilizing cloud-native microservices and asynchronous messaging for scalable content management. By integrating large-scale data aggregation, predictive AI crawler modeling, digital twin-based AI response simulation, reinforcement learning-driven optimization, and automated multi-channel distribution, the disclosed system provides a comprehensive, automated solution for enhancing content visibility and sentiment in AI-driven conversational platforms. The system thus enables dynamic, real-time optimization of AI-generated responses for brand or content promotion and sentiment enhancement.

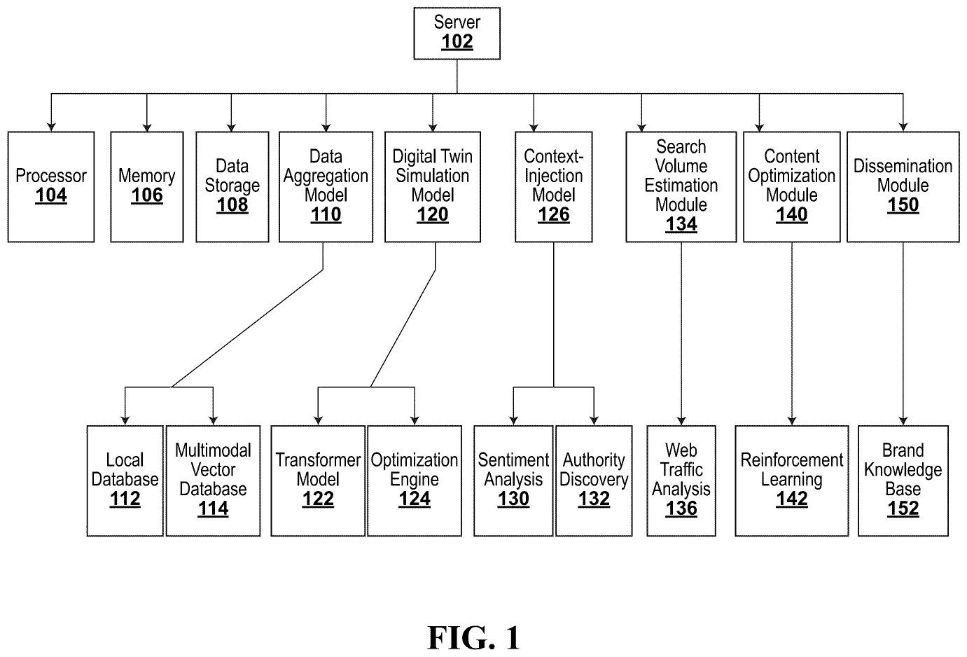

With reference to the drawings, system 100, as depicted in FIG. 1, includes server 102. Server 102 comprises processor 104, memory 106, and data storage 108, wherein the processor executes computational tasks, the memory facilitates data access, and the data storage archives processed information. A data aggregation module 110 is responsible for collecting and preprocessing large-scale AI-generated response data, interfacing with local database storage 112 for temporary data retention and a multimodal vector database 114 for storing structured vectorized embeddings of AI-generated responses, aiding in subsequent analytical processes.

A digital twin simulation module 120 replicates AI conversational platform behaviour, supporting structured testing of content optimization strategies. The digital twin module includes a fine-tuned transformer model 122, which serves as a surrogate model trained on historical AI responses, and an optimization engine 124, responsible for iteratively refining content using loss-guided reinforcement learning techniques. A context-injection module 126 dynamically integrates external authoritative data, ensuring that modifications align with AI-preferred phrasing and terminology.

A sentiment and visibility analysis module 128 evaluates content prominence and sentiment polarity using natural language processing (NLP)-based scoring 130, which computes content representation within AI-generated responses over time. This module also includes authority source discovery 132, identifying high-impact references shaping AI responses. A predictive AI search volume estimation module 134 models search activity trends using web crawler traffic data 136 to estimate the frequency at which AI platforms retrieve and reference specific content.

A content optimization module 140 iteratively modifies brand-related text, guided by reinforcement learning-based feedback 142 and structured re-ranking mechanisms 144, ensuring content improvements maximize inclusion in AI-generated responses. A dissemination module 150 supports strategic deployment of optimized content to brand knowledge bases 152, high-authority publications 154, and structured metadata repositories 156, increasing the likelihood of AI models ingesting and favorably referencing the content.

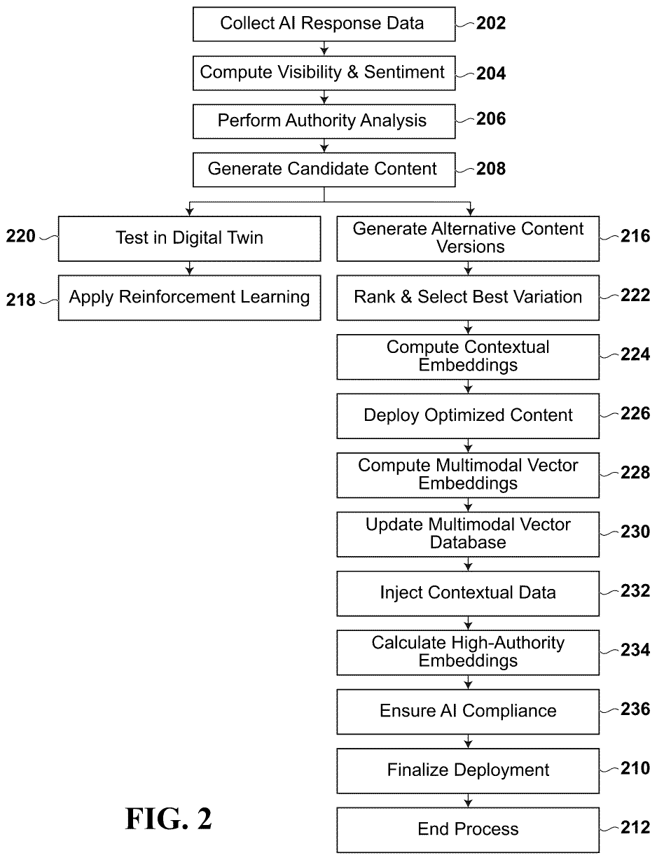

With reference to FIG. 2, an exemplary method for optimizing content visibility and sentiment begins with collecting AI-generated response data at 202, aggregating responses from multiple AI conversational platforms. At 204, the system calculates baseline visibility and sentiment scores, establishing a reference for optimization. At 206, an authority analysis is performed to compare AI responses with authoritative external content, generating a profile of content strengths, weaknesses, and missing information. At 208, the system generates candidate content modifications, iteratively refining structure, phrasing, and factual accuracy. These modifications are tested within the digital twin simulation at 220, which replicates AI platform behaviour to evaluate how modified content influences AI-generated responses. At 218, the optimization engine applies loss-guided reinforcement learning, minimizing the divergence between AI-generated responses and the target optimized content. At 216, alternative content versions are generated and ranked at 222, selecting the best-performing variation for deployment. At 224, contextual embedding generation ensures that the content aligns with AI indexing mechanisms, while at 226, the system deploys optimized content to AI training corpora. At 228, multimodal vector embeddings are computed, structuring content representations for long-term AI retrievability. The multimodal vector database is updated at 230, ensuring that future AI-generated responses incorporate the latest optimizations.

Still with reference to FIG. 2, at 232, context-injection within the generative system integrates dynamic market data, competitive intelligence, and topic-based embeddings to align content modifications with emerging AI trends. At 234, the system calculates embeddings of top-ranked authoritative sources, reinforcing AI alignment with high-trust data sources. At 236, marketplace-specific content compliance ensures that optimizations adhere to AI model constraints and content ingestion requirements. The method concludes with deploying the optimized content at 210, marking the end at 212.

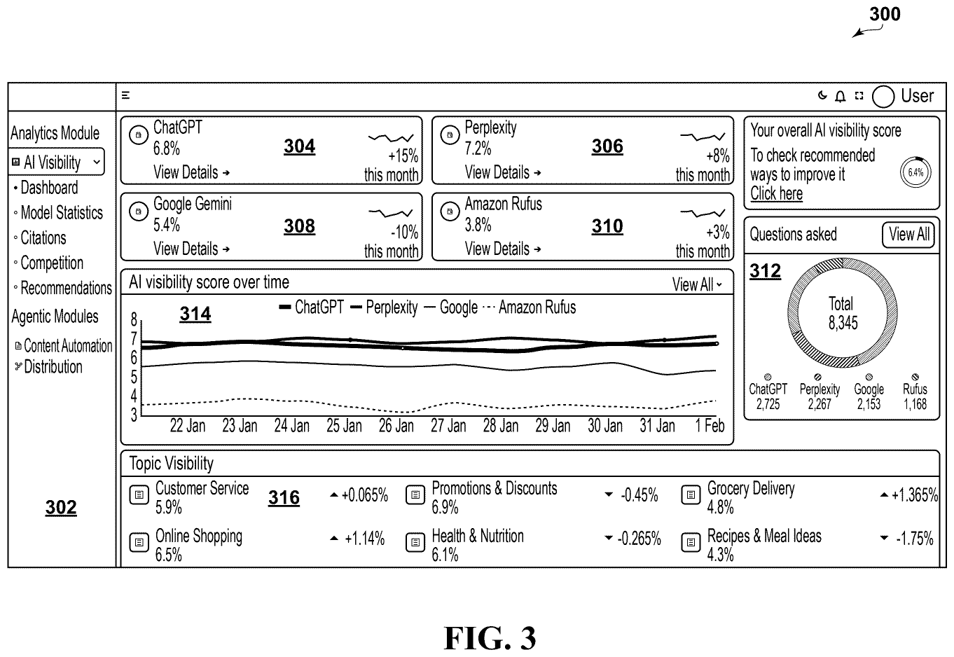

Turning to FIG. 3 through FIG. 7, these user interface screens illustrate exemplary embodiments of the system, providing a graphical representation of the functionalities described herein. The user interfaces facilitate interaction with the AI-driven brand optimization process by enabling topic submission, automated data collection, sentiment analysis, citation aggregation, and the generation of actionable recommendations. These interfaces present real-time insights, allowing users to evaluate key performance metrics and implement targeted optimizations to enhance brand visibility across AI conversational platforms. These user-facing controls provides an intuitive mechanism for monitoring AI-generated responses and executing adjustments based on dynamically updated system analytics. The subsequent figures depict exemplary user screens and their corresponding functionalities.

With reference to FIG. 3, the system facilitates customer-driven topic submission and analysis to determine brand visibility across AI conversational platforms. Screenshot 300 depicts a topic submission interface, where the customer inputs a list of topics 302 relevant to their brand, business interests, or industry. The system automatically dispatches these topics to multiple AI conversational platforms (e.g., ChatGPT™ Perplexity™, Google Gemini™, and Amazon Rufus™ as non-limiting examples) for evaluation. The system computes a Visibility Score (V) according to Equation 1 as described above, displayed at areas 304, 306, 308, and 310, corresponding to the AI conversational platforms. The total number of submitted queries is shown in the Questions Asked area 312. Dashboard 314 presents an interactive view of visibility trends over time, allowing users to track how frequently their brand appears in AI-generated content. The topic visibility area 316 provides a breakdown of brand presence across different topics of interest.

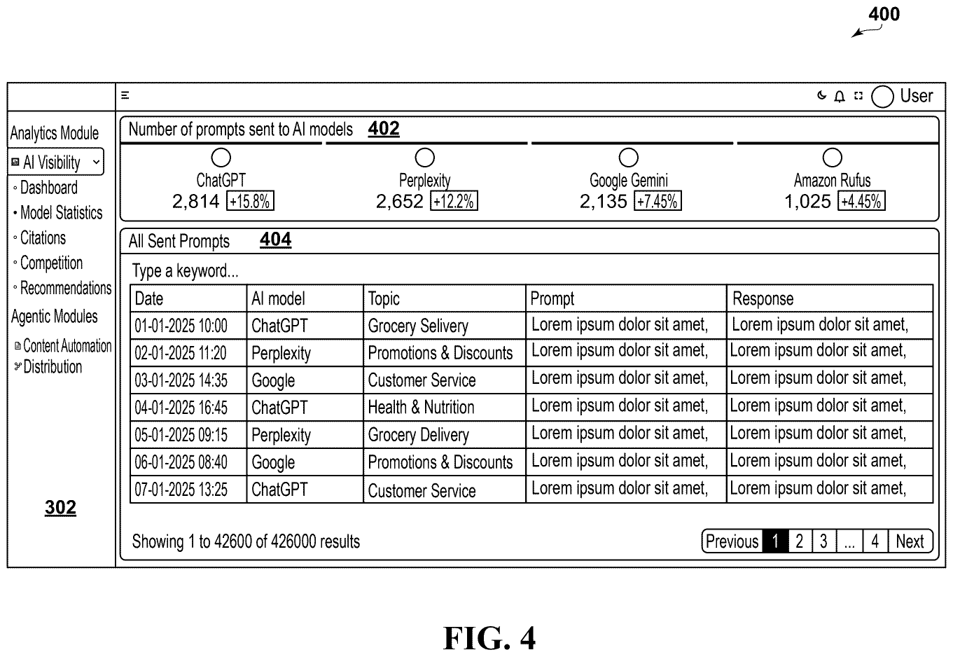

With reference to FIG. 4, the system implements automated data collection by continuously querying AI conversational platforms. Screenshot 400 represents the querying interface, where a question generation model 402 generates thousands of end-user inquiries based on topic prediction models. To account for the probabilistic nature of AI-generated responses, the system submits each question multiple times, ensuring diverse response sampling. The list of questions is shown in 404. A daily querying scheduler (not shown in FIG. 4) can automatically dispatch generated questions to AI conversational platforms, recording multiple response variations for increased dataset accuracy. The dataset is continuously updated, capturing evolving AI-generated perceptions of the brand.

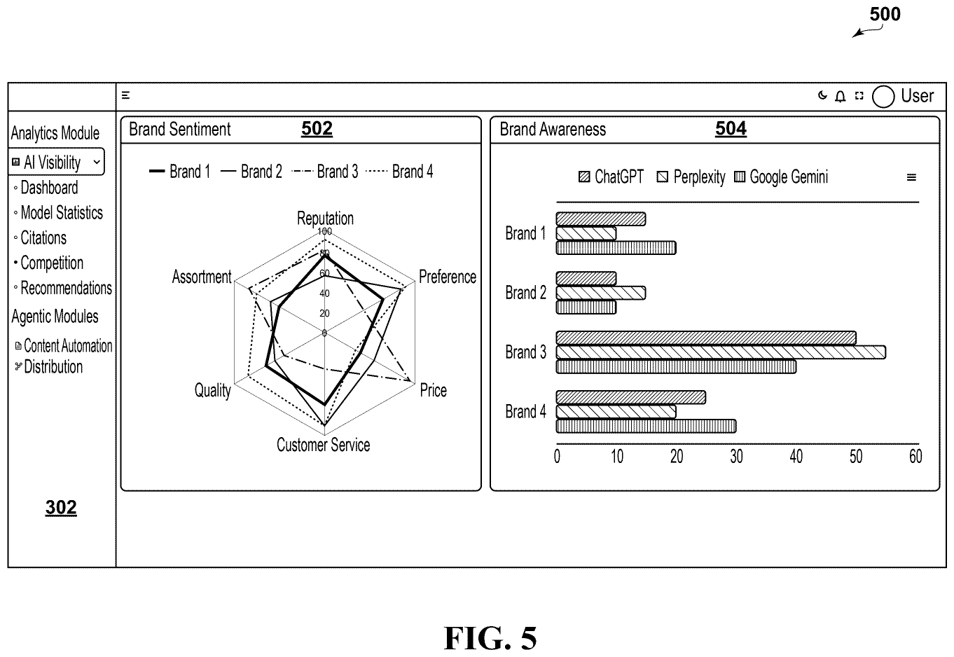

With reference to FIG. 5, the system applies sentiment analysis and data visualization techniques to assess brand perception. Screenshot 500 represents a high-level visualization of AI-generated brand sentiment trends and awareness levels. The sentiment analysis visualization 502 extracts polarity scores (positive, neutral, negative) from AI-generated responses, categorizing sentiment trends based on six key attributes: Reputation, Preference, Price, Customer Service, Quality, and Assortment. A dashboard reporting system 504 aggregates key performance indicators (KPIs), visualizing sentiment scores in comparison with competitors. The interactive dashboard enables brand managers to evaluate comparative sentiment trends and track AI-driven perception shifts over time.

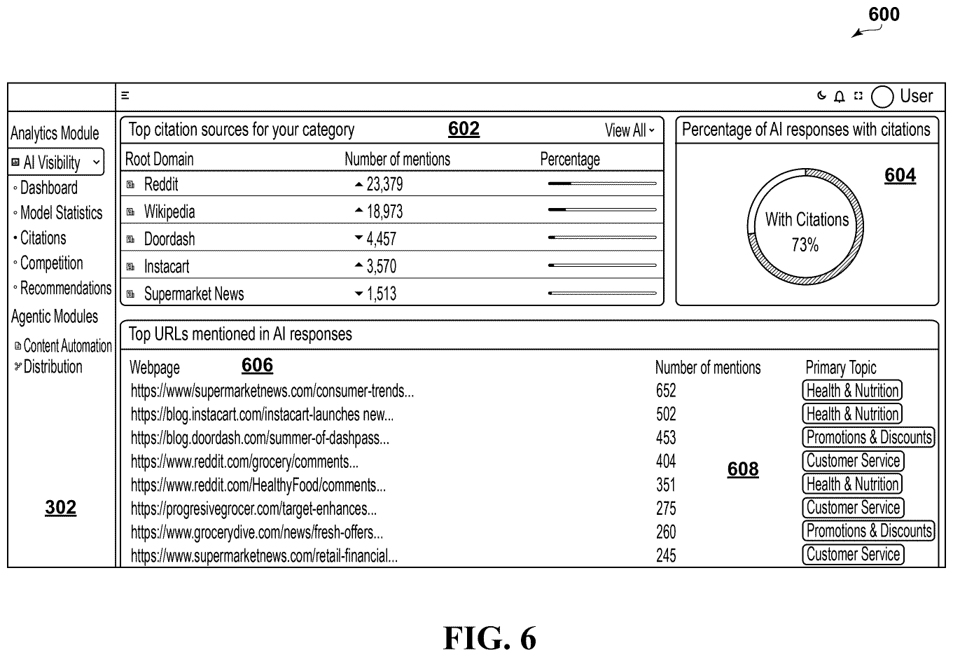

Turning to FIG. 6, the system allows users to review citation aggregation and authority analysis to determine which external sources influence AI-generated responses. Screenshot 600 presents an overview of citation analysis. The citation collection module extracts referenced URLs embedded in AI responses, storing them in a structured dataset, shown at area 602. The authority identification module analyzes citation frequency, domain authority, and source credibility, highlighting high-authority platforms for specific topics. The system further includes a citation relevance analysis module to determine the weight and influence of individual citations in AI responses. Area 604 displays the percentage of AI responses that include citations, providing insight into the extent to which external sources contribute to AI-generated content. Area 606 presents a list of top URLs mentioned in AI-generated responses, ranking them based on frequency and topic relevance. Area 608 categorizes the number of mentions by topic, enabling users to assess the distribution of brand-related citations across various subject areas.

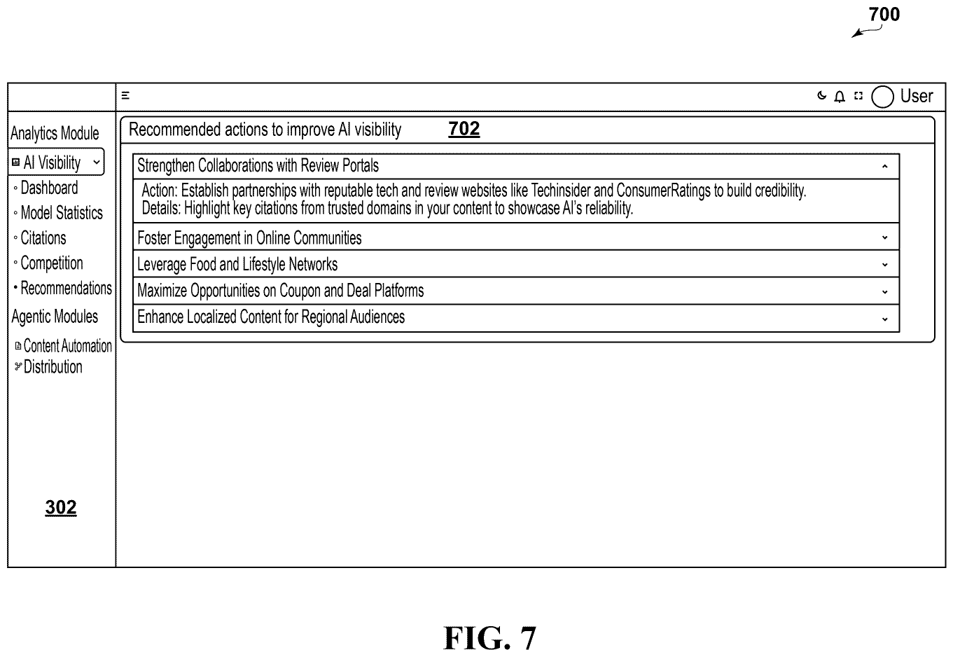

With reference to FIG. 7, the system generates actionable recommendations based on analyzed data, offering both manual and automated execution options. Screenshot 700 provides a recommendations dashboard where the system presents a ranked list of optimization strategies. The strategic guidance module 702 generates targeted recommendations, which may include optimizing content distribution through high-authority sources, increasing engagement within relevant online networks, identifying strategic partnership opportunities across industry-specific platforms, refining promotional strategies to maximize discoverability, and adapting content to align with regional and demographic variations. The system evaluates these recommendations based on visibility metrics, sentiment analysis, and citation authority data to prioritize optimization strategies that improve AI-generated brand representation.

The system and methods described herein provide a structured approach to improving content visibility and sentiment within AI-driven conversational platforms. While the described implementation refers to brand optimization, the techniques can be applied more broadly to areas such as content reliability assessment, automated trend analysis, and adaptive content positioning. The modular design allows for adjustments as AI models evolve, supporting integration with new data sources and refinement of optimization strategies over time. Variations in implementation may be made depending on specific use cases, while remaining within the scope of the present disclosure.

The system could be extended to optimize placement and ranking of sponsored content on conversational platforms. For example, the system could analyze the integration of sponsored responses relative to organic outputs by tracking retrieval mechanisms, response generation pathways, and ranking algorithms used by AI platforms. A sponsored content indexing module could assess how AI models classify and retrieve sponsored entries in comparison to non-sponsored material, identifying structural patterns, keyword dependencies, and semantic weightings that affect response selection. The system could use techniques to determine the conditions under which sponsored content is most likely to be surfaced by AI-generated queries. By submitting controlled variations of brand-related prompts and monitoring differential response behaviour, the system could infer model-specific content weighting mechanisms and refine sponsored material accordingly. The system could incorporate dynamic bidding optimization, where an AI sponsorship placement evaluator assesses the trade-off between prominence and engagement. This evaluator could simulate sponsored vs. organic response competitions within a digital twin model of the conversational AI, allowing for pre-deployment testing of content effectiveness. Based on these simulations, the system could iteratively refine parameters to ensure the highest return on sponsored content investment. Real-time monitoring could be enabled to track sentiment shifts, engagement metrics, and user retention patterns in response to AI-generated sponsored content.

In scenarios where AI platforms impose sponsorship disclosure constraints, the system could employ interpretability models to assess how disclosure labels influence response weighting and user engagement. The system could then adjust content delivery strategies to ensure that sponsored material remains effective even when explicitly marked as promotional.

This framework would allow for an adaptive, data-driven approach to AI-sponsored content optimization, ensuring that sponsored responses are not only surfaced within AI-generated conversations but also presented in a manner that aligns with user intent, engagement objectives, and platform-specific response generation constraints.

The exemplary system architecture, interfaces, and tools depicted in the drawings can be substituted, varied, or altered without departing from the scope of the present specification. For example, the dashboard layout used to visualize content visibility, sentiment analysis, and optimization progress could be customized to suit different user preferences or operational requirements. Elements such as AI response logs, digital twin test results, and authority source rankings could be rearranged, added, or removed based on evolving user needs. Furthermore, the specific functionalities of AI-driven content modification, authority discovery, and feedback loop iteration could be enhanced or simplified depending on system requirements. Alternative AI models or machine learning techniques could be integrated to refine sentiment scoring, response simulation, or content optimization processes. A streamlined version of the tool could be offered for users with limited computational resources, while an advanced version could incorporate customizable optimization parameters and real-time AI monitoring tools. The user interface design may be varied to support different device types, accessibility needs, or user interaction methods, such as touch, voice commands, or API-based integrations. The system can be implemented as a web-based, mobile, or desktop application to enhance usability and flexibility across different operational contexts.

The system architecture and computational framework, as outlined in the present specification, allow for flexibility in handling diverse AI conversational models and large-scale data processing tasks. The computer hardware for the system is designed to support multiple AI architectures, including large language models, retrieval-augmented generation models, and transformer-based neural networks, ensuring compatibility with a wide range of conversational AI platforms. The system manages data collection, aggregation, normalization, and analysis, enabling continuous optimization of AI-generated content through automated feedback loops. The digital twin simulation provides a controlled environment for testing content optimizations, allowing iterative refinements without directly modifying live AI platforms. The system supports cloud-based deployment, providing scalable computing resources and enabling real-time adaptation to changes in AI model behaviour. Networking capabilities allow integration with multiple AI platforms, tracking content representation across different chatbot ecosystems and ensuring that content modifications are optimized for broad adoption across distributed AI architectures.

Embodiments of the present specification use digital twin simulations to replicate conversational AI responses, allowing structured content optimization based on controlled testing environments. The skilled reader will appreciate that authority analysis and iterative feedback mechanisms enhance the system's adaptability, enabling real-time content refinement based on AI-generated outputs. The technique of content alignment with authoritative sources ensures that modifications maintain factual accuracy while improving content prominence and sentiment within AI-generated responses. The optimization engine employs machine learning techniques such as gradient-based loss minimization, reinforcement learning for response evaluation, and transformer-based content rewriting, allowing flexible refinement strategies. However, the skilled reader will appreciate that the system extends beyond digital twin-based optimization, incorporating natural language processing (NLP)-driven semantic analysis, vector-based retrieval models for relevance scoring, and reinforcement learning-based iterative tuning. Multi-agent optimization frameworks can be used to test different content variations in parallel, ensuring improvements across diverse AI conversational platforms.

One general aspect includes a method performed on a server, which includes a processor, memory, data storage, and a network interface device connected to a network. The method involves collecting and aggregating data from one or more AI-driven conversational platforms, including retrieving a set of user queries and corresponding AI-generated responses related to a target content and computing baseline metrics of content visibility and sentiment from the responses. The method further includes instantiating a digital twin model or simulation of an AI conversational model, wherein the digital twin is configured with the target content and simulates the behaviour of a live conversational platform, enabling controlled testing of AI-generated responses in an isolated environment. The method includes identifying authoritative sources by comparing the test responses with external content corpora, wherein an authority analysis module determines which external content pieces or data sources influence the responses for topics related to the target content and generates an authority profile indicating strengths and weaknesses of the target content relative to the external content pieces or data sources. The method further includes iteratively optimizing the target content via a feedback loop, including generating one or more modified versions of the target content or associated metadata based on insights from the authority profile and predefined optimization rules, wherein the modifications are configured to improve at least one of content coverage of missing information, alignment with authoritative phrasing or tone, and sentiment conveyed. The modified content is input into the digital twin model and re-run against a plurality of test queries to obtain simulated responses. The method includes evaluating the simulated responses by an automated analysis to measure updated content visibility and sentiment metrics and determining whether the updated metrics meet predefined improvement criteria or require further iteration. If further iteration is required, the method refines the content modifications and repeats the simulation and evaluation steps until the improvement criteria are met or a termination condition is reached. The method further includes deploying the optimized content configuration to the live AI conversational platform or an associated content repository such that subsequent AI-generated responses incorporate the optimizations.

Implementations may include one or more of the following features: The method includes automatically submitting a set of prompts to each of a plurality of different AI-driven conversational platforms on a periodic schedule and storing the resulting answers along with metadata in a data store for analysis. The method includes computing a visibility score that quantifies how frequently the target content appears in responses from the conversational agents over a defined time window and performing NLP-based sentiment analysis on the responses to assign sentiment scores reflecting positive or negative tone toward the target content. The method includes instantiating the digital twin model by using the collected prompts and test responses to fine-tune a secondary language model such that the responses are statistically correlated with the test responses, and validating the digital twin model by comparing the responses to the test responses. The method includes using the digital twin model to simulate the conversational agent's response to candidate content modifications, and wherein an optimization engine or module iteratively adjusts the candidate content by minimizing a difference between the test responses and a target content. The method includes calculating a loss function that measures deviation of the digital twin model's output from an ideal output containing a predefined level of content prominence or sentiment and automatically modifying elements of the candidate content (meaning modified versions of the target content) to reduce the loss function until a termination criterion is reached. The method includes monitoring web traffic or crawler logs to detect visits by AI-related web crawlers to online content and ranking candidate information sources based on frequency or pattern of crawler visits, thereby inferring which sources are indexed or utilized by the AI conversational platforms for knowledge about the target content. The method includes instantiating the digital twin model as an instance of the conversational AI model, configured in a sandbox environment to replicate the response behaviour of the live platform, and wherein the digital twin is enriched with the target content by at least one of injecting the content into the prompt context for the model, integrating the content into a retrieval index accessible by the model, or fine-tuning the model's parameters on the target content, such that the twin's responses to test queries reflect the influence of the target content in a manner comparable to how a live platform would incorporate that content. The method includes identifying authoritative sources by using natural language processing techniques to trace AI response elements to probable origins, comprising performing similarity matching between segments of AI responses and candidate reference documents, querying the AI model (or twin) with reverse prompts to elicit possible data sources, and ranking identified external documents by an authority score, the authority score being derived from factors comprising document provenance, frequency of reference in AI responses, and content overlap with the AI's answers, thereby producing a ranked list of external sources that the AI model considers authoritative for the subject matter. The method includes storing an authority profile of the target content that includes a structured representation of content gaps and tone differences and generating specific content improvements using the authority profile, such that if the authority profile indicates a content gap that is present in high-authority sources but absent in the target content, the optimization module automatically augments the target content with that information while maintaining factual accuracy, and if the authority profile indicates a tone or terminology mismatch wherein authoritative sources use a different tone or vocabulary than the target content, the optimization module rewrites parts of the target content to align with the authoritative tone or terminology. The method includes computing updated quantitative metrics comprising at least a visibility metric and a sentiment polarity metric for the target content in the AI responses, and wherein the improvement criteria require that the visibility metric exceed a certain threshold and the sentiment metric fall within a desired range. The method includes applying an automated sentiment analysis model to each AI response that mentions the target content, classifying the sentiment of the mention as positive, negative, or neutral, and aggregating these classifications into an overall sentiment score for that iteration, and wherein the content optimization module adjusts the target content in response to sentiment feedback by modifying or adding contextual sentences that address negative aspects or highlight positive aspects. The method includes generating content modifications in the optimizing step using an AI-based content generation subsystem that suggests or produces rewritten content. The method includes filtering AI-generated content suggestions using rules or human-defined constraints so that the optimized content is accurate and does not introduce misinformation before deploying the changes in the simulation. The method includes using the digital twin model to test multiple alternative content strategies in parallel, wherein in one iteration, the method branches into testing two or more different content variations, comprising a first variation that is concise and fact-focused and a second variation that is narrative and example-driven, by running separate sets of test queries on each variation within separate twin instances, and then comparing which variation yields better visibility and sentiment metrics, and wherein the method then selects the superior content variation for continued optimization or final deployment. The method includes collecting aggregated data from multiple heterogeneous conversational AI platforms comprising different chatbot services or voice assistants and normalizing the content visibility and sentiment metrics across these platforms. The method includes presenting a dashboard via a user interface that visualizes the performance of the target content and the effects of each optimization iteration, including graphs or tables of the visibility and sentiment over iterations, the identified top authoritative sources, and the changes made to the content. The method includes entering a continuous monitoring mode after deploying the optimized content, in which the system detect shifts in AI responses due to external model updates and trigger re-optimization as needed.

The implementation of the method for optimizing content visibility and sentiment in AI-driven conversational platforms can be executed either on a system or via a non-transitory computer-readable storage medium. In the case of a system, it would include components like memory to store instructions and a processor configured to execute these instructions. Alternatively, the same set of instructions could be stored on a non-transitory computer-readable storage medium.

While the invention has been described with reference to the specific embodiments, it will be understood by those skilled in the art that various changes may be made without departing from the scope of the present specification. Furthermore, the scope of the present specification is not intended to be limited to the specific embodiments described herein. The range of embodiments described herein is not intended to limit the scope of the present specification. Rather, the invention encompasses all modifications and variations within the scope of the present specification.

1. A method performed on a server comprising a processor, a memory, a data storage, and a network interface device connected to a network, the method comprising:
collecting and aggregating data from one or more AI-driven conversational platforms, including retrieving a set of user queries and corresponding AI-generated responses related to a target content, and computing baseline metrics of content visibility and sentiment from the responses;
instantiating a digital twin model of an AI conversational model, wherein the digital twin model is configured with the target content and simulates the behaviour of a live conversational platform, enabling controlled testing of AI test responses in an isolated environment;
identifying authoritative sources by comparing the test responses with external content corpora, wherein an authority analysis module determines which external content pieces or data sources influence the responses for topics related to the target content, and generates an authority profile indicating strengths and weaknesses of the target content relative to the external content pieces or data sources;
iteratively optimizing the target content via a feedback loop, comprising:
generating one or more modified versions of the target content or associated metadata based on insights from the authority profile and predefined optimization rules, the modifications configured to improve at least one of: content coverage of missing information, alignment with authoritative phrasing or tone, and sentiment conveyed;
inputting the modified content into the digital twin model and re-running a plurality of test queries to obtain simulated responses;
evaluating, by an automated analysis, the simulated responses to measure updated content visibility and sentiment metrics; and
determining, based on the evaluation, whether the updated metrics meet predefined improvement criteria or require further iteration, and if further iteration is required, refining the content modifications and repeating the simulation and evaluation steps until the improvement criteria are met or a termination condition is reached;
deploying the optimized content configuration to the live AI conversational platform or an associated content repository such that subsequent AI-generated responses incorporate the optimizations.

2. The method of claim 1, wherein collecting data comprises automatically submitting a set of prompts to each of a plurality of different AI-driven conversational platforms on a periodic schedule and storing the resulting answers along with metadata in a data store for analysis.

3. The method of claim 1, wherein analyzing the aggregated response data includes computing a visibility score that quantifies how frequently the target content appears in responses from the conversational agents over a defined time window, and performing NLP-based sentiment analysis on the responses to assign sentiment scores reflecting positive or negative tone toward the target content.

4. The method of claim 1, wherein instantiating the digital twin model comprises using the collected prompts and test responses to fine-tune a secondary language model such that the responses are statistically correlated with the test responses, and validating the digital twin model by comparing the responses to the test responses.

5. The method of claim 1, further comprising using the digital twin model to simulate the conversational agent's response to modified versions of the target content, and wherein an optimization module iteratively adjusts the modified versions of the candidate content by minimizing a difference between the test responses and the target content.

6. The method of claim 5, wherein iteratively adjusting the modified versions of the target content comprises calculating a loss function that measures deviation of the digital twin model's output from an ideal output containing a predefined level of content prominence or sentiment, and automatically modifying elements of the modified versions of the target content to reduce the loss function until a termination criterion is reached.

7. The method of claim 1, further comprising monitoring web traffic or crawler logs to detect visits by AI-related web crawlers to online content, and ranking candidate information sources based on frequency or pattern of crawler visits, thereby inferring which sources are indexed or utilized by the AI conversational platforms for knowledge about the target content.

8. The method of claim 1, wherein the digital twin model comprises an instance of the conversational AI model, configured in a sandbox environment to replicate the response behaviour of the live platform, and wherein the digital twin is enriched with the target content by at least one of:
injecting the content into the prompt context for the model;
integrating the content into a retrieval index accessible by the model, or
fine-tuning the model's parameters on the target content, such that the twin's responses to test queries reflect the influence of the target content in a manner comparable to how a live platform would incorporate that content.

9. The method of claim 1, wherein the step of identifying authoritative sources further comprises using natural language processing techniques to trace AI response elements to probable origins, comprising:
performing similarity matching between segments of AI responses and candidate reference documents, querying the AI model (or twin) with reverse prompts to elicit possible data sources; and
ranking identified external documents by an authority score, the authority score being derived from factors comprising document provenance, frequency of reference in AI responses, and content overlap with the AI's answers, thereby producing a ranked list of external sources that the AI model considers authoritative for the subject matter.

10. The method of claim 1, wherein the authority profile of the target content includes a structured representation of content gaps and tone differences, and the optimizing step uses this profile to generate specific content improvements, such that:
if the authority profile indicates a content gap that is present in high-authority sources but absent in the target content, an optimization module automatically augments the target content with that information, maintaining factual accuracy; and
if the profile indicates a tone or terminology mismatch wherein authoritative sources use a different tone or vocabulary than the target content, the optimization module rewrites parts of the target content to align with the authoritative tone or terminology, thereby increasing the likelihood that the AI will recognize and trust the content.

11. The method of claim 1, wherein evaluating the simulated AI responses in each iteration of the optimizing step comprises:
computing updated quantitative metrics comprising at least:
a visibility metric and a sentiment polarity metric for the target content in the AI responses, and wherein the improvement criteria require that the visibility metric exceed a certain threshold and the sentiment metric fall within a desired range, so that the content is portrayed favourably in the AI's output.

12. The method of claim 11, wherein the sentiment polarity metric is obtained by applying an automated sentiment analysis model to each AI response that mentions the target content, classifying the sentiment of the mention as positive, negative, or neutral, and aggregating these classifications into an overall sentiment score for that iteration, and wherein an optimization module adjusts the target content in response to sentiment feedback by modifying or adding contextual sentences that address negative aspects or highlight positive aspects, thereby guiding towards a more positive or neutral description of the content in subsequent iterations.

13. The method of claim 1, wherein the content modifications in the optimizing step are generated at least in part by an AI-based content generation subsystem that uses machine learning models to suggest or produce rewritten content.

14. The method of claim 13, wherein the content generation subsystem:
takes as input the identified gaps or desired changes from the identifying authoritative sources step and outputs candidate revised text; and
filters the candidate revised text using rules or human-defined constraints so that the optimized content is accurate, and does not introduce misinformation, prior to deploying the changes in the simulation.

15. The method of claim 1, wherein the digital twin model is also used to test multiple alternative content strategies in parallel; wherein in one iteration, the method branches into testing two or more different content variations, comprising a first variation that is concise and fact-focused, and a second variation that is narrative and example-driven, by running separate sets of test queries on each variation within separate twin instances, and then comparing which variation yields better visibility and sentiment metrics; and wherein the method then selects the superior content variation for continued optimization or final deployment.

16. The method of claim 1, wherein the aggregated data collected in the collecting step is derived from multiple heterogeneous conversational AI platforms comprising different chatbot services or voice assistants, and the method further comprises normalizing the content visibility and sentiment metrics across these platforms.

17. The method of claim 1, further comprising presenting, via a user interface, a dashboard that visualizes the performance of the target content and the effects of each optimization iteration, including graphs or tables of the visibility and sentiment over iterations, the identified top authoritative sources, and the changes made to the content.

18. The method of claim 1, wherein after deploying the optimized content, the system enters a continuous monitoring mode in which it periodically repeats the method.

19. A system for optimizing content visibility and sentiment in AI-driven conversational platforms, comprising:
a memory storing instructions; and
a processor configured to execute the instructions to:
collect and aggregate data from one or more AI-driven conversational platforms, including retrieving a set of user queries and corresponding AI-generated responses related to a target content, and computing baseline metrics of content visibility and sentiment from the responses;
instantiate a digital twin model of an AI conversational model, wherein the digital twin is configured with the target content and simulates the behaviour of a live conversational platform, enabling controlled testing of AI responses in an isolated environment;
identify authoritative sources by comparing the responses with external content corpora, wherein an authority analysis module determines which external content pieces or data sources influence the responses for topics related to the target content, and generates an authority profile indicating strengths and weaknesses of the target content relative to the external content pieces or data sources;
iteratively optimize the target content via a feedback loop, comprising:
generate one or more modified versions of the target content or associated metadata based on insights from the authority profile and predefined optimization rules, the modifications configured to improve at least one of: content coverage of missing information, alignment with authoritative phrasing or tone, and sentiment conveyed;
input the modified content into the digital twin model and re-running a plurality of test queries to obtain simulated responses;
evaluate, by an automated analysis, the simulated responses to measure updated content visibility and sentiment metrics; and
determine, based on the evaluation, whether the updated metrics meet predefined improvement criteria or require further iteration, and if further iteration is required, refining the content modifications and repeating the simulation and evaluation steps until the improvement criteria are met or a termination condition is reached;
deploy the optimized content configuration to the live AI conversational platform or an associated content repository such that subsequent AI-generated responses incorporate the optimizations.

20. A non-transitory computer-readable storage medium storing instructions that, when executed by a processor, perform a method comprising:
collecting and aggregating data from one or more AI-driven conversational platforms, including retrieving a set of user queries and corresponding AI-generated responses related to a target content, and computing baseline metrics of content visibility and sentiment from the responses;
instantiating a digital twin model of an AI conversational model, wherein the digital twin is configured with the target content and simulates the behaviour of a live conversational platform, enabling controlled testing of AI responses in an isolated environment;
identifying authoritative sources by comparing the responses with external content corpora, wherein an authority analysis module determines which external content pieces or data sources influence the responses for topics related to the target content, and generates an authority profile indicating strengths and weaknesses of the target content relative to the external content pieces or data sources;
iteratively optimizing the target content via a feedback loop, comprising:
generating one or more modified versions of the target content or associated metadata based on insights from the authority profile and predefined optimization rules, the modifications configured to improve at least one of: content coverage of missing information, alignment with authoritative phrasing or tone, and sentiment conveyed;
inputting the modified content into the digital twin model and re-running a plurality of test queries to obtain simulated responses;
evaluating, by an automated analysis, the simulated responses to measure updated content visibility and sentiment metrics; and
determining, based on the evaluation, whether the updated metrics meet predefined improvement criteria or require further iteration, and if further iteration is required, refining the content modifications and repeating the simulation and evaluation steps until the improvement criteria are met or a termination condition is reached;
deploying the optimized content configuration to the live AI conversational platform or an associated content repository such that subsequent AI-generated responses incorporate the optimizations.
